(19) United States
(12) Patent Application Publication
(10) Pub. No.: US 2026/0269444 A1
(43) Pub. Date: Sep. 10, 2026

(54) RADIO FREQUENCY FILTERS ON FEED BOARDS

(71) Applicant: CommScope Italy S.R.L., Agrate Brianza (IT)

(72) Inventor: Stefano Tamiazzo, Milano (IT)

(21) Appl. No.: 18/850,189

(22) PCT Filed: Mar. 29, 2023
(86) PCT No.: PCT/EP2023/058097

§ 371 Date: Sep. 24, 2024

(30) Foreign Application Priority Data
Apr. 26, 2022 (IT) 102022000008183

(51) Int. Cl. H01P 1/205; H01P 1/212; H01Q 1/24; H04B 7/04

(52) U.S. Cl. CPC H01P 1/207; H01P 1/2088; H01P 1/212; H01P 7/06; H01P 7/065; H01Q 1/00; H01Q 1/405

(57) ABSTRACT

Radio frequency (RF) devices are provided. An RF device includes a feed board that has a first surface having a plurality of radiating elements thereon. Moreover, the RF device includes a filter bank having a plurality of RF filters that each include a plurality of resonators that are on a second surface of the feed board that is opposite the first surface. Related methods of forming a plurality of filter chassis are also provided.

### FIELD

The present disclosure relates to communications systems and, in particular, to radio frequency (“RF”) filters.

### BACKGROUND

Base station antennas for wireless communications systems are used to provide cellular communications service to fixed and mobile users that are within defined coverage areas of the respective base station antennas. These base station antennas typically include one or more linear arrays or two-dimensional arrays of radiating elements, such as dipole, or crossed-dipole, radiating elements that act as individual antenna elements. Each of these arrays may be connected to one or more RF ports. The RF ports are used to pass RF signals between the arrays and one or more radios.

Example base station antennas are discussed in International Publication No. WO 2017/165512 to Bisiules, U.S. patent application Ser. No. 15/921,694 to Bisiules et al., and U.S. Patent Application No. 63/024,846 to Hamdy et al., the disclosures of which are hereby incorporated herein by reference in their entireties. Many cellular base stations include RF filters that are mounted within a base station antenna or on an antenna tower adjacent the base station antenna. As an example, a cellular base station may include (i) a base station antenna having one or more arrays of radiating elements, (ii) a radio that is coupled to the array(s), and (iii) one or more RF filters that are coupled between the radio and the array(s). For example, the RF filter(s) may be part of an RF feed network for the array(s).

### SUMMARY

An RF device, according to some embodiments, may include a feed board including a first surface having a plurality of radiating elements thereon. Moreover, the RF device may include a filter bank including a plurality of RF filters that each have a plurality of resonators that are mounted on a second surface of the feed board that is opposite the first surface.

In some embodiments, the second surface of the feed board may have a ground plane thereon, and the resonators may be mounted on the ground plane. Moreover, the second surface of the feed board may have an RF transmission line thereon, a first portion of an underside of a first of the resonators may overlap the RF transmission line, and a second portion of the underside of the first of the resonators may overlap the ground plane.

According to some embodiments, a second of the resonators may have opposite first and second ends that are both coupled to the ground plane. For example, the first and second ends may be ends of first and second leg portions, respectively, of the second of the resonators. Moreover, the second of the resonators may have a third leg portion that is coupled to the ground plane.

In some embodiments, the RF device may include a cover that covers the resonators. Moreover, the RF device may include a plurality of tuning elements that are coupled to some of the resonators and do not extend through the cover.

According to some embodiments, the underside of the first of the resonators may have a suspended surface that is opposite and spaced apart from the second surface of the feed board. Moreover, the first of the resonators may have first and second leg portions that support the suspended surface of the first of the resonators.

In some embodiments, the resonators may be sheet-metal resonators, respectively. Moreover, the sheet-metal resonators may be soldered to the feed board.

According to some embodiments, the RF device may include a low-pass filter that is coupled to the filter bank. For example, the low-pass filter may be on the first surface or the second surface of the feed board.

In some embodiments, the RF device may include a conductive wall that electrically isolates a first of the RF filters from a second of the RF filters.

According to some embodiments, a first of the resonators may include first and second leg portions having a distance therebetween that narrows as the first and second leg portions approach the second surface of the feed board.

In some embodiments, a first and a second of the resonators may be part of the same metal sheet. Moreover, the first of the resonators may include a protruding portion that protrudes toward, and is capacitively coupled to, the second of the resonators. A linking portion of the metal sheet may inductively couple the first and the second of the resonators to each other.

According to some embodiments, the RF device may include an RF transmission line on the second surface of the feed board. A first, a second, and a third of the resonators may each be electrically connected to the RF transmission line and may be in different resonator cavities from each other.

An RF device, according to some embodiments, may include a feed board that includes a first surface having a plurality of radiating elements thereon, and a second surface opposite the first surface and having a ground plane thereon. Moreover, the RF device may include a filter bank on the second surface of the feed board. The filter bank may include a plurality of RF filters that each have a plurality of sheet-metal resonators that are coupled to the ground plane.

In some embodiments, the second surface of the feed board may include a plurality of RF transmission lines thereon. Moreover, the sheet-metal resonators may include first resonators that overlap the RF transmission lines, and second resonators that each have at least two leg portions that are coupled to the ground plane.

An RF device, according to some embodiments, may include a feed board including a ground plane thereon and an RF transmission line thereon. Moreover, the RF device may include a filter bank on the ground plane. The filter bank may include a plurality of RF filters that each have a plurality of resonators that are coupled to the ground plane. A first portion of an underside of a first of the resonators may overlap the RF transmission line. A second portion of the underside of the first of the resonators may overlap the ground plane.

In some embodiments, a second of the resonators may have at least three leg portions that are mounted on the ground plane.

A method of forming a plurality of filter chassis, according to some embodiments, may include forming a preliminary chassis structure having at least four outer conductive walls and at least three inner conductive walls that physically connect two of the outer conductive walls to each other. Moreover, the method may include cutting the preliminary chassis structure into the plurality of filter chassis.

In some embodiments, forming the preliminary chassis structure may include extruding metal in a first direction. Moreover, cutting the preliminary chassis structure may include cutting the extruded metal along a second direction that is perpendicular to the first direction.

### BRIEF DESCRIPTION OF THE DRAWINGS

FIG. 1A is a front perspective view of a base station antenna, according to embodiments of the present invention.

FIG. 1B is a front perspective view of the base station antenna of FIG. 1A electrically connected to a radio.

FIG. 1C is a schematic block diagram of ports of the base station antenna of FIG. 1A electrically connected to ports of the radio of FIG. 1B.

FIG. 2A is a rear perspective view of an RF filter bank of the filter device of FIG. 1C, according to embodiments of the present invention.

FIG. 2B is a rear perspective view of the RF filter bank of FIG. 2A with the cover removed.

FIG. 2C is a rear perspective view of the feed board of FIG. 2B.

FIG. 2D is a rear perspective view of the conductive walls of FIG. 2B.

FIG. 2E is a schematic side view of the feed board of FIG. 2C.

FIG. 2F is a side perspective view of one of the resonators of FIG. 2B.

FIG. 2G is a rear perspective view of the resonator of FIG. 2F.

FIG. 2H is an enlarged view of a portion of the RF filter bank of FIG. 2B.

FIG. 3A is a rear perspective view of an RF filter bank with its cover removed, according to other embodiments of the present invention.

FIG. 3B is a rear perspective view of one of the resonators of FIG. 3A.

FIG. 3C is a side perspective view of another type of resonator that can be part of the RF filter bank of FIG. 3A.

FIGS. 3D and 3E are examples of further types of RF filters that can be part of the RF filter bank of FIG. 3A.

FIG. 3F is a schematic side view of the feed board of FIG. 3A with a cover thereon.

FIG. 4 is a flowchart illustrating operations of forming the conductive walls of FIG. 2D.

### DETAILED DESCRIPTION

Pursuant to embodiments of the present invention, RF devices are provided that increase integration between a cellular base station antenna and RF filters that are coupled between a radio and radiating elements of the antenna. Such integration may be desirable in the case of, for example, a massive multi-input-multi-output (“MIMO”) antenna, for which it may be advantageous to reduce size (e.g., dimensions and/or weight) and cost.

In some embodiments, a filter bank and a feed board may be a single, integrated component rather than separate components. For example, the filter bank may be surface-mounted on the rear surface (i.e., back side) of the feed board. As an example, resonators of the filter bank may be surface-mounted on a ground plane that is on the rear surface of the feed board, and the filter bank may thereby use the ground plane as a conductive wall thereof. A plurality of radiating elements may extend forward from a front surface of the feed board that is opposite the rear surface. The integrated filter bank and feed board may help to reduce the dimensions, weight, and/or cost of a cellular base station antenna while providing good thermal compensation and RF performance.

Example embodiments of the present invention will be described in greater detail with reference to the attached figures.

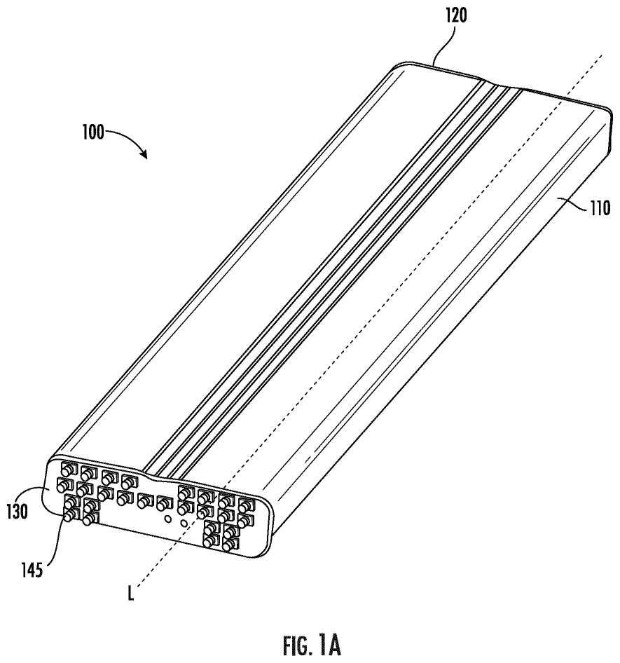

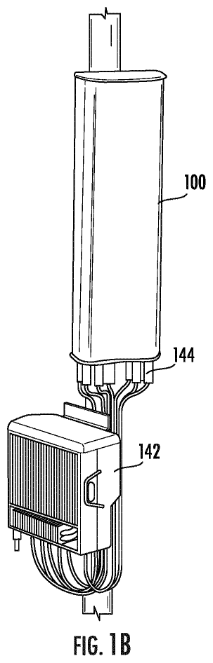

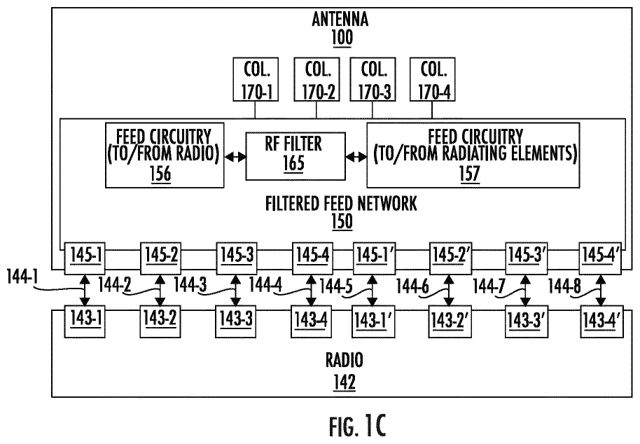

FIG. 1A is a front perspective view of a base station antenna 100, according to embodiments of the present invention. The antenna 100 may be, for example, a cellular base station antenna at a macrocell base station or at a small cell base station. As shown in FIG. 1A, the antenna 100 is an elongated structure and has a generally rectangular shape. The antenna 100 includes a radome 110. In some embodiments, the antenna 100 further includes a top end cap 120 and/or a bottom end cap 130. The bottom end cap 130 may include a plurality of RF connectors 145 mounted therein. The connectors 145, which may also be referred to herein as “ports,” are not limited, however, to being located on the bottom end cap 130. Rather, one or more of the connectors 145 may be provided on, for example, the rear (i.e., back) side of the radome 110 that is opposite the front side of the radome 110. The antenna 100 is typically mounted in a vertical configuration (i.e., the long side of the antenna 100 extends along a vertical axis L with respect to Earth).

FIG. 1B is a front perspective view of the base station antenna 100 electrically connected to a radio 142 by RF transmission lines 144, such as coaxial cables. For example, the radio 142 may be a cellular base station radio, and the antenna 100 and the radio 142 may be located at (e.g., may be components of) a cellular base station. In some cases, the radio 142 may be mounted on the back surface of the antenna 100 rather than below the antenna 100.

FIG. 1C is a schematic block diagram of ports 145 of the base station antenna 100 electrically connected to respective ports 143 of the radio 142. As shown in FIG. 1C, ports 145-1 through 145-4 of the antenna 100 are electrically connected to ports 143-1 through 143-4, respectively, of the radio 142 by respective RF transmission lines 144-1 through 144-4, such as coaxial cables. Similarly, ports 145-1′ through 145-4′ of the antenna 100 are electrically connected to ports 143-1′ through 143-4′, respectively, of the radio 142 by respective RF transmission lines 144-5 through 144-8. The ports 145-1 through 145-4 may transmit and/or receive RF signals in the same frequency band as the ports 145-1′ through 145-4′, or in a different frequency band from the ports 145-1′ through 145-4′. For simplicity of illustration, only eight ports 145 are shown in FIG. 1C. In some embodiments, however, the antenna 100 may include twelve, twenty, thirty, or more ports 145. Moreover, though all of the ports 143 are shown as being part of a single radio 142, it will be appreciated that the ports 143 may alternatively be spread across multiple radios 142.

The antenna 100 may transmit and/or receive RF signals in one or more frequency bands, such as one or more bands comprising frequencies between 3.4 gigahertz (“GHz”) and 3.8 GHz. For example, the antenna 100 may, in some embodiments, transmit and/or receive RF signals in all or a portion of the band(s), while rejecting RF signals outside of the band(s).

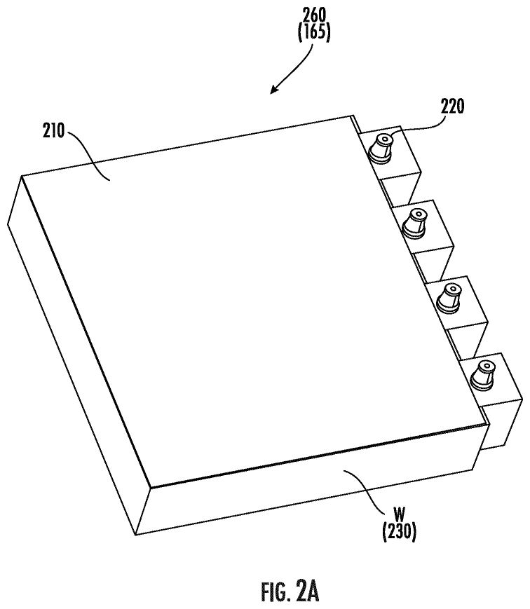

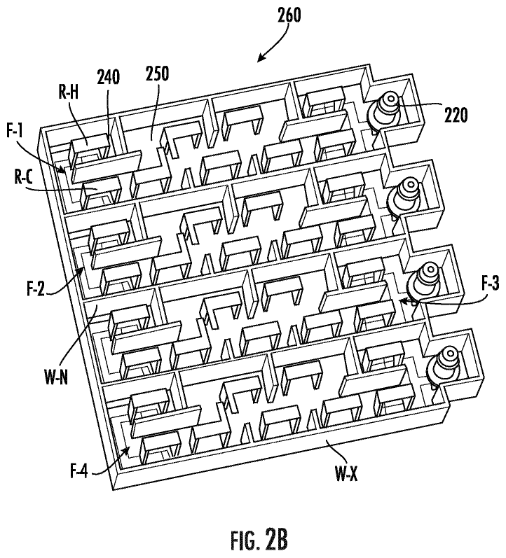

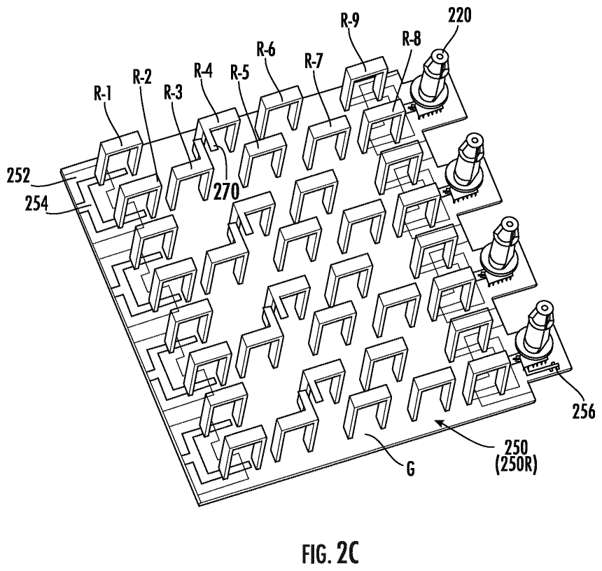

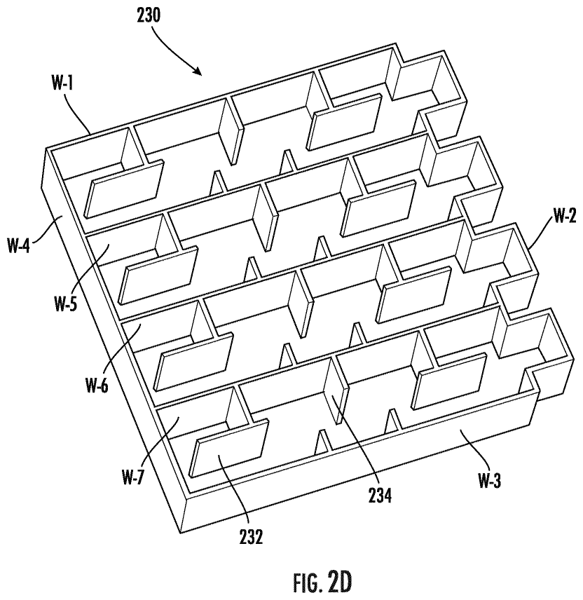

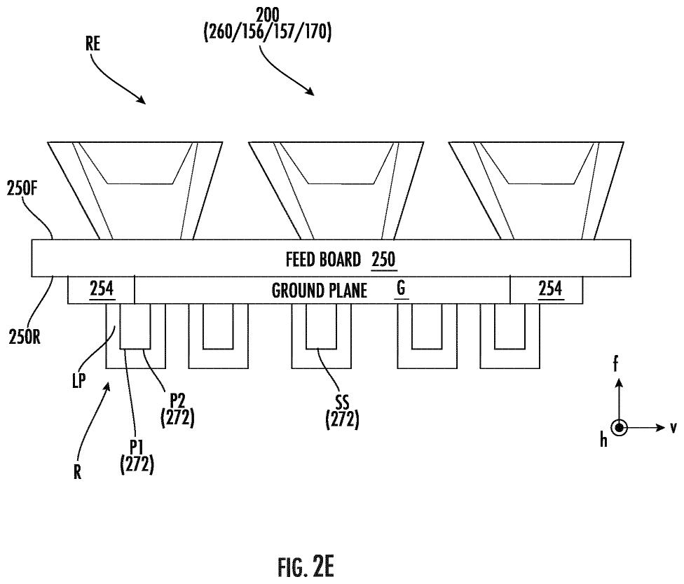

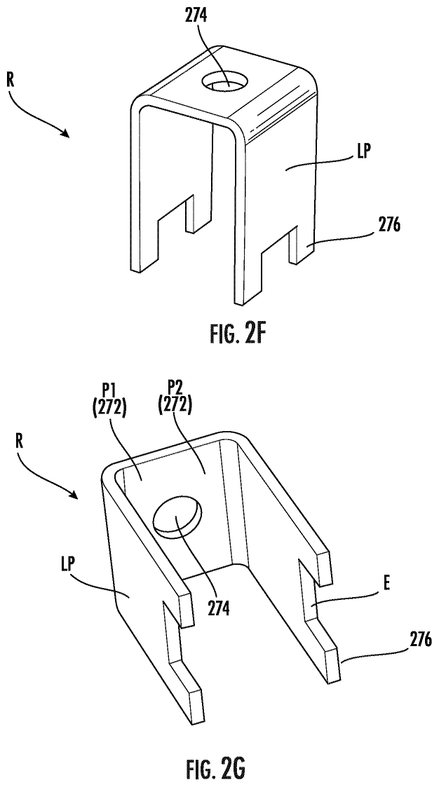

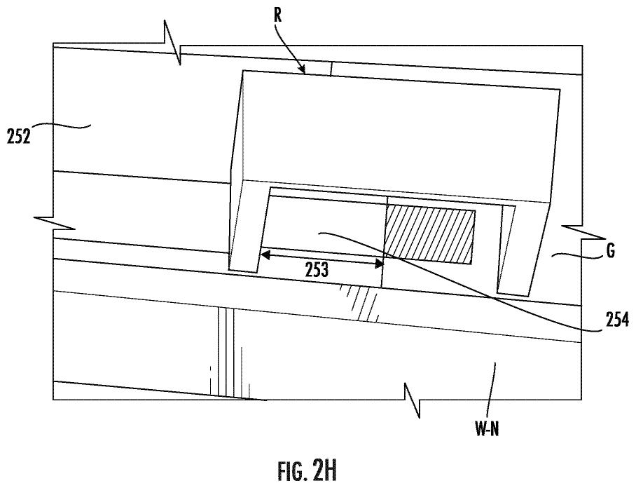

The antenna 100 may include arrays (e.g., vertical columns) 170-1 through 170-4 of radiating elements RE (FIG. 2E) that are configured to transmit and/or receive RF signals. The antenna 100 may also include a filtered feed network 150 that is coupled between the arrays 170 and the radio 142. For example, the arrays 170 may be coupled to respective RF transmission paths (e.g., including one or more RF transmission lines) of the feed network 150.

The arrays 170 may be spaced apart from each other in a horizontal direction h (FIG. 2E) and may each extend in a vertical direction v (FIG. 2E) from a lower portion of an antenna assembly to an upper portion of the antenna assembly. The vertical direction v may be, or may be parallel with, the longitudinal axis L (FIG. 1A). The vertical direction v may also be perpendicular to the horizontal direction h and a forward direction f. As used herein, the term “vertical” does not necessarily require that something is exactly vertical (e.g., the antenna 100 may have a small mechanical down-tilt).

The arrays 170 are each configured to transmit and/or receive RF signals in one or more frequency bands, such as one or more bands comprising frequencies between 3.4 GHz and 3.8 GHz. Though FIG. 1C illustrates four arrays 170-1 through 170-4, the antenna assembly may include more (e.g., five, six, or more) or fewer (e.g., three, two, or one) arrays 170. Moreover, the number of radiating elements RE in an array 170 can be any quantity from two to twenty or more. For example, the four arrays 170-1 through 170-4 shown in FIG. 1C may each have three to twenty radiating elements RE. According to some embodiments, the arrays 170 may each have the same number (e.g., eight) of radiating elements RE.

In some embodiments, the feed network 150 may include one or more RF filter devices 165. Feed circuitry 156 of the feed network 150 may be coupled between each filter device 165 and the radio 142. The feed network 150 may also include feed circuitry 157 that is coupled between the filter device(s) 165 and the arrays 170. The circuitry 156/157 can couple downlink RF signals from the radio 142 to radiating elements RE that are in arrays 170. The circuitry 156/157 may also couple uplink RF signals from radiating elements RE that are in arrays 170 to the radio 142. For example, the circuitry 156/157 may include power dividers, RF switches, RF couplers, and/or RF transmission lines that couple the filter device(s) 165 between the radio 142 and the arrays 170.

Moreover, the antenna 100 may include phase shifters that are used to electronically adjust the tilt angle of the antenna beams generated by each array 170. The phase shifters may be located at any appropriate location along the RF transmission paths that extend between the ports 145 and the arrays 170. Accordingly, though omitted from view in FIG. 1C for simplicity of illustration, the feed network 150 may include phase shifters.

FIG. 2A is a rear perspective view of a filter device 165 comprising an RF filter bank 260, according to embodiments of the present invention. As used herein, the term “filter bank” refers to a group of RF filters. For example, each filter bank 260 may include four or more RF filters. According to some massive MIMO embodiments, the antenna 100 (FIG. 1C) may comprise, for example, 32 or more (e.g., 32-64) RF filters. As an example, the antenna 100 may comprise 4-8 filter banks 260, each of which may include four or more RF filters. In some embodiments, the filter device 165 may comprise a plurality of filter banks 260. In other embodiments, the antenna 100 may comprise a plurality of filter devices 165 that comprise respective filter banks 260.

The filter device 165 includes a cover 210 that covers a rear of the filter bank 260. As an example, the cover 210 may be a conductive cover, such as a tuning cover that is configured to tune resonators R (FIG. 2B) of the filter bank 260. The cover 210 rests on top of a conductive housing 230 having conductive walls W that define cavities in which the resonators R are configured to resonate. The housing 230 may also be referred to herein as a “filter chassis.”

The filter device 165 also includes a plurality of RF connectors 220 that are coupled to the radio 142 (FIG. 1C). For example, each RF filter of the filter bank 260 may be coupled to the radio 142 via a respective connector 220. In some embodiments, the connectors 220 may be coupled to the radio 142 via the connectors 145 (FIG. 1C) of the antenna 100. The connectors 220 may be one of various types of RF connectors, such as pin-type connectors or SMP-MAX connectors.

In some embodiments, the filter bank 260 may be part of an RF device 200 (FIG. 2E) in which the filter bank 260 is integrated with a plurality of radiating elements RE (FIG. 2E). For example, the filter bank 260 and the radiating elements RE may be integrated on a feed board 250 (FIG. 2E) that both (i) feeds the radiating elements RE and (ii) provides a ground plane G (FIG. 2C) for the filter bank 260. The filter device 165 (including the filter bank 260 thereof) that is shown in FIG. 2A thus may be implemented as one side of the device 200 rather than implemented as a dedicated filter device that is separate from the feed board 250, and the radiating elements RE may be implemented on an opposite side of the device 200 (e.g., an opposite side of the feed board 250).

A height of the device 200 may be, for example, less than 20 millimeters (“mm”). A length of the device 200 may be less than 100 mm. According to some embodiments, however, a low-pass filter may be included in the device 200, which may extend the length beyond 100 mm.

FIG. 2B is a rear perspective view of the filter bank 260 of FIG. 2A with the cover 210 (FIG. 2A) removed. As shown in FIG. 2B, the filter bank 260 includes four RF filters F-1 through F-4, each of which is coupled to a respective connector 220. Each filter F includes a plurality of resonators R. For example, each filter F may include nine resonators R, as shown in FIG. 2B. Seven of the nine resonators R may be capacitively-coupled resonators R-C that are each capacitively coupled to at least one other of the resonators R-C. The remaining two resonators R may be hanging-rejection resonators R-H that are in respective hanging-rejection cavities 240 that are electrically isolated from capacitive couplings of the resonators R-C. Each hanging-rejection resonator R-H may be coupled to an adjacent resonator R via a transmission-line trace on the feed board 250.

The conductive walls W of the conductive housing 230 (FIG. 2A) may include at least four outer conductive walls W-X and at least three inner conductive walls W-N that may extend continuously to physically connect two of the outer conductive walls W-X to each other. The connectors 220 may be either inside or outside of the outer walls W-X. Each inner wall W-N may electrically isolate a pair of the filters F from each other. For example, an inner wall W-N may electrically isolate the first filter F-1 from the second filter F-2. Another inner wall W-N may electrically isolate the second filter F-2 from the third filter F-3, and a further inner wall W-N may electrically isolate the third filter F-3 from the fourth filter F-4. According to some embodiments, the filters F may be respective band-pass filters, which may be configured to pass frequencies between 3.4 GHz and 3.8 GHz.

The filter bank 260 is on a feed board 250. In some embodiments, the feed board 250 may comprise feed circuitry 157 (FIG. 1C) that is coupled between the filter bank 260 and radiating elements RE (FIG. 2E) that are on an opposite side of the feed board 250 from the resonators R.

FIG. 2C is a rear perspective view of the feed board 250 of FIG. 2B. For simplicity of illustration, the conductive walls W of FIG. 2B are omitted from view in FIG. 2C. As shown in FIG. 2C, the resonators R are on a rear surface 250R of the feed board 250 that is opposite a front surface 250F (FIG. 2E) that has radiating elements RE (FIG. 2E) thereon. For example, the first filter F-1 (FIG. 2B) may include nine resonators R-1 through R-9. As used herein, the term “rear perspective view” is relative to (e.g., opposite) a view that faces the front surface 250F.

The seven resonators R-2 through R-8 may be capacitively-coupled resonators R-C (FIG. 2B), and the remaining two resonators R-1 and R-9 may be hanging-rejection resonators R-H (FIG. 2B). As an example, the adjacent resonators R-2, R-3 may be capacitively coupled to each other, the adjacent resonators R-3, R-4 may be capacitively coupled to each other, the adjacent resonators R-4, R-5 may be capacitively coupled to each other, the adjacent resonators R-5, R-6 may be capacitively coupled to each other, the adjacent resonators R-6, R-7 may be capacitively coupled to each other, and the adjacent resonators R-7, R-8 may be capacitively coupled to each other. In some embodiments, the adjacent resonators R-3, R-4 may have respective laterally-protruding portions 270 that are capacitively coupled to each other. The adjacent resonators R-3, R-4 can thus be capacitively coupled to each other even if leg portions LP (FIG. 2F) thereof do not laterally overlap. Others of the resonators R-C may be capacitively coupled to each other by laterally-overlapping leg portions LP.

Because the resonator R-1 may not be capacitively coupled to the adjacent resonator R-2, these two resonators R may be coupled to each other by an RF transmission line 254 that is on the rear surface 250R of the feed board 250. For example, the transmission line 254 may be on a dielectric substrate 252 of the feed board 250, and one end E (FIG. 2G) of each of the resonators R-1, R-2 may be on and coupled to the transmission line 254. An opposite end E of each of the resonators R-1, R-2 may be on and coupled to a ground plane G that is on the rear surface 250R of the feed board 250. The adjacent resonators R-8, R-9 may likewise be coupled to each other by another RF transmission line 254 that is on the rear surface 250R of the feed board 250. Moreover, both (i.e., opposite) ends E of each of the five resonators R-3 through R-7 may be on and coupled to the ground plane G. The ground plane G may comprise, for example, copper.

According to some embodiments, the resonators R of each filter F may provide four transmission zeros. For example, resonators R-2 through R-4 may collectively provide one transmission zero, resonators R-5 through R-8 may collectively provide another transmission zero, and each of the two hanging-rejection cavities 240 (FIG. 2B) may provide a transmission zero.

The resonators R may be mounted (e.g., soldered) on the rear surface 250R of the feed board 250. In some embodiments, a low-pass filter (“LPF”) 256 that is coupled to the filter bank 260 (FIG. 2B), such as coupled to resonators R of the fourth filter F-4 (FIG. 2B), may also be on the rear surface 250R, depending on the availability of space thereon. For example, the LPF 256 may comprise a metal trace (e.g., of a microstrip line) having one or more metal stubs protruding therefrom on a dielectric substrate 252 of the feed board 250. The LPF 256 may be configured to cut off spurious/parasitic resonances (e.g., frequencies above 3.8 GHz). Moreover, as shown in FIG. 2C, the LPF 256 may be adjacent and/or coupled to a connector 220. In other embodiments, the LPF 256 may be on the front surface 250F of the feed board 250 or may be outside of the conductive housing 230 (FIG. 2A). As an example, the LPF 256 may be adjacent and/or coupled to a connection (e.g., a plated through hole (“PTH”)) between a filter F and radiating elements RE.

FIG. 2D is a rear perspective view of the conductive walls W of FIG. 2B. The walls W include outer walls W-X (FIG. 2B) and inner walls W-N (FIG. 2B) of the conductive housing 230 of FIG. 2A. The outer walls W-X include four outer conductive walls W-1 through W-4. The inner walls W-N include three inner conductive walls W-5 through W-7 that extend continuously to physically connect opposite outer walls W-2, W-4 to each other.

Short walls 234 may extend (e.g., perpendicularly) from the walls W-1, W-3, and W-5 through W-7. Moreover, short walls 232 may extend (e.g., perpendicularly) from some of the walls 234. For example, a wall 232 may electrically isolate adjacent resonators R-1, R-2 (FIG. 2C) from each other, and thus may define the hanging-rejection cavity 240 (FIG. 2B). As another example, a wall 234 may electrically isolate adjacent resonators R-4, R-6 (FIG. 2C) from each other. Accordingly, though the resonators R-4, R-6 may be arranged with (e.g., aligned with) each other in a first row, the resonators R-4, R-6 may be capacitively coupled to (a) resonators R that are in a different, second row rather than (b) each other. As an example, the resonators R-3, R-5, and R-7 may be arranged with (e.g., aligned with) each other in the second row, the resonator R-4 may be capacitively coupled to the resonators R-3, R-5, and the resonator R-6 may be capacitively coupled to the resonators R-5, R-7.

The walls W may be formed in a variety of ways. For example, the walls W may be formed by diecasting aluminum or by metallizing plastic. As another example, the walls W may be formed by extrusion. In some embodiments, the walls W may be formed by three-dimensional (“3D”) printing. An example method of forming the walls W is described in greater detail herein with respect to FIG. 4.

FIG. 2E is a schematic side view of the feed board 250 of FIG. 2C. For simplicity of illustration, the connectors 220 of FIG. 2C are omitted from view in FIG. 2E. The feed board 250 is part of an RF device 200, which integrates the filter bank 260 of a filter device 165 with a plurality of radiating elements RE (e.g., of the same array 170) on the feed board 250. The radiating elements RE may be coupled to resonators R of the filter bank 260 by one or more PTHs in the feed board 250, which PTHs are omitted from view in FIG. 2E for simplicity of illustration. In some embodiments, the device 200 may also include feed circuitry 156/157 (FIG. 1C) on the feed board 250.

As shown in FIG. 2E, the resonators R may project rearwardly from the rear surface 250R of the feed board 250. An underside 272 of each resonator R may face the rear surface 250R. For example, the underside 272 of each resonator R may comprise a suspended surface SS that is opposite, spaced apart from, and/or parallel to a ground plane G that is on the rear surface 250R. The suspended surface SS may be supported by two leg portions LP of each resonator R. Moreover, the underside 272 (e.g., the suspended surface SS thereof) of some resonators R, such as resonators R-1, R-2, R-8, R-9 (FIG. 2C), may include a first portion Pl that overlaps (and is spaced apart from), in a forward direction f, an RF transmission line 254 that couples a pair of resonators R to each other. According to some embodiments, each filter F may comprise two pairs of resonators R that overlap two transmission lines 254, respectively. A second portion P2 of the underside 272 overlaps (and is spaced apart from), in the forward direction f, the ground plane G.

The forward direction f may be perpendicular to a horizontal direction h and a vertical direction v. In some embodiments, a row of four or more resonators R may be arranged/aligned with each other in the vertical direction v. In other embodiments, the row of four or more resonators R may be arranged/aligned with each other in the horizontal direction h, which may be perpendicular to the vertical direction v.

FIG. 2E also shows that a plurality of radiating elements RE may extend forward, in the forward direction f, from a front surface 250F of the feed board 250 that is opposite the rear surface 250R. Each filter F (FIG. 2B) will feed all radiating elements RE on the feed board 250, which will typically be two to four radiating elements RE. Accordingly, the filter bank 260 shown in FIG. 2B as having four filters F-1 through F-4 may be coupled to eight to sixteen radiating elements RE that are on the opposite side of the feed board 250 from the filter bank 260. In embodiments in which the antenna 100 (FIG. 1C) comprises a MIMO antenna with sixty-four filters F, the filters F may collectively feed at least one hundred twenty-eight radiating elements RE. Moreover, in some cases, each filter F may feed as many as six radiating elements RE.

The radiating elements RE may have various shapes and/or structures, and thus are not limited to the example shapes/structures shown in FIG. 2E. For example, the radiating elements RE may be sheet-metal radiating elements that may be implemented with various shapes and/or feeding techniques.

FIG. 2F is a side perspective view of one of the resonators R of FIG. 2B. As shown in FIGS. 2B and 2F, the resonators R may be arch-shaped resonators. The resonators R are not limited, however, to a particular shape. Rather, as the length of the resonators R determines the resonant frequency thereof, the shape can vary. For example, the resonators R may be C-shaped, U-shaped, semicircular, or another shape.

According to some embodiments, the resonators R may be stamped from a metal sheet, and thus may be low-cost sheet-metal resonators that can be soldered to the feed board 250 (FIG. 2E). Moreover, the resonators R may comprise steel, which can provide better temperature compensation than other conductive materials. For example, steel may expand and/or contract less than aluminum. In some embodiments, the resonators R may be formed from a steel sheet.

A top surface, such as a suspended surface SS (FIG. 2E), of the resonator R may, in some embodiments, have an opening 274 therein. In other embodiments, the opening 274 may be omitted. For simplicity of illustration, the opening 274 is omitted from view in FIGS. 2B, 2C. Moreover, one or more (e.g., a pair of) stubs 276 may project from each leg portion LP of the resonator R. Each stub 276 may be soldered into a through hole in the feed board 250 (FIG. 2C).

FIG. 2G is a rear perspective view of the resonator R of FIG. 2F. As shown in FIG. 2G, each resonator R has two opposite ends E. For example, each end E may be an end of a respective leg portion LP. The ends E of resonators R-3 through R-7 (FIG. 2C) may each be coupled to a ground plane G (FIG. 2C). As an example, those ends E may be soldered to the ground plane G. A first end E of resonators R-1, R-2, R-8, R-9 may be coupled (e.g., soldered) to an RF transmission line 254 (FIG. 2C), and a second end E of the resonators R-1, R-2, R-8, R-9 may be coupled (e.g., soldered) to the ground plane G. The ends E may be soldered to the ground plane G or the transmission line 254 of the feed board 250 (FIG. 2E) either in addition to or as an alternative to soldering the stubs 276 to through holes in the feed board 250.

FIG. 2G also shows that an underside 272 of the resonator R may have first and second portions P1, P2. For some resonators R, the first and second portions P1, P2 thereof may overlap a transmission line 254 and the ground plane G, respectively, in a forward direction f as shown in FIG. 2E. For other resonators R, the first and second portions P1, P2 thereof may both overlap (in the forward direction f) the ground plane G and may not overlap (in the forward direction f) any transmission line 254 that is on the rear surface 250R of the feed board 250 (FIG. 2E). As used herein with respect to two elements, the term “overlap” refers to an axis that extends through the two elements.

FIG. 2H is an enlarged view of a portion of the filter bank 260 of FIG. 2B. As shown in FIG. 2H, a portion of a resonator R may overlap an RF transmission line 254. For example, respective portions P1 (FIG. 2G) of resonators R-1, R-2, R-8, R-9 (FIG. 2C) may each overlap and be spaced apart from a transmission line 254. Moreover, end portions E (FIG. 2G) of the resonators R-1, R-2, R-8, R-9 may be on and physically/electrically connected (e.g., via ohmic/galvanic coupling rather than capacitive coupling) to the transmission lines 254. A transmission line 254 may comprise a metal trace on a dielectric substrate 252. In some embodiments, the portions P1 of the resonators R-1, R-2, R-8, R-9 may also overlap exposed (non-metallized) portions of the dielectric substrate 252, as the resonators R-1, R-2, R-8, R-9 may each be wider than the metal trace. Respective portions P2 (FIG. 2G) of the resonators R-1, R-2, R-8, R-9 may each overlap and be spaced apart from a ground plane G that is adjacent the exposed portions of the dielectric substrate 252. An end of the transmission line 254 may be connected to the ground plane G.

Various electromagnetic coupling levels can be used with respect to filter input/output nodes that are adjacent/coupled to the transmission lines 254 and/or the resonators R-1, R-2, R-8, R-9. For example, a level of electromagnetic coupling at a filter input that is adjacent the resonators R-1, R-2 can be arbitrarily set, as may a level of electromagnetic coupling at a filter output that is adjacent the resonators R-8, R-9. In some embodiments, electromagnetic coupling between a filter input/output and a resonator R (such as electromagnetic coupling (a) between the input and the resonator R-1, (b) between the input and the resonator R-2, (c) between the output and the resonator R-8, or (d) between the output and the resonator R-9) can be independently set at a desired level by adjusting a length 253 between (i) an end portion E of the resonator R that overlaps and is coupled to the transmission line 254 and (ii) an edge portion of the ground plane G (e.g., an interface between the ground plane G and the substrate 252) that is overlapped by the underside 272 (FIG. 2G) of the resonator R.

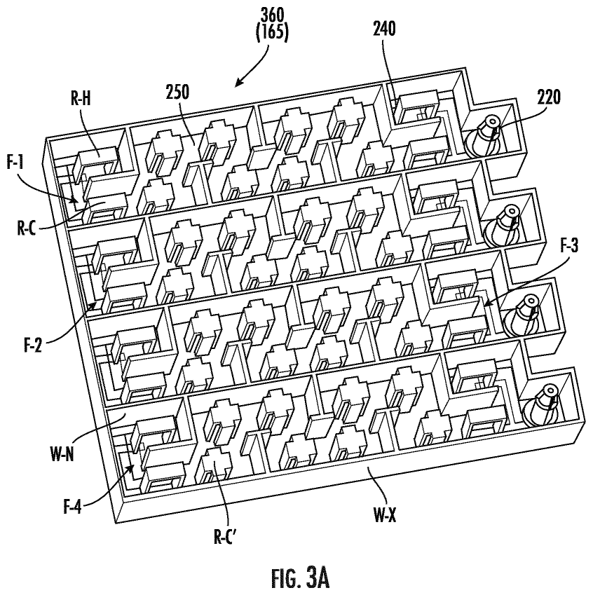

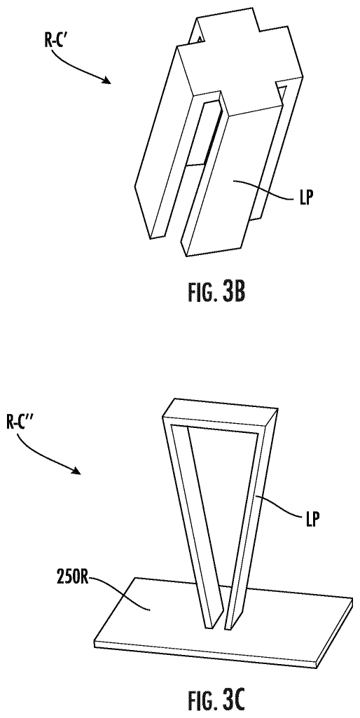

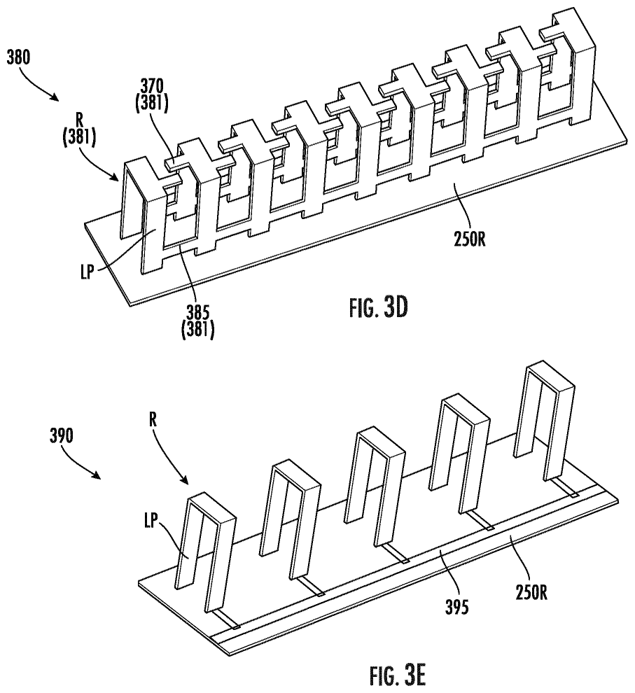

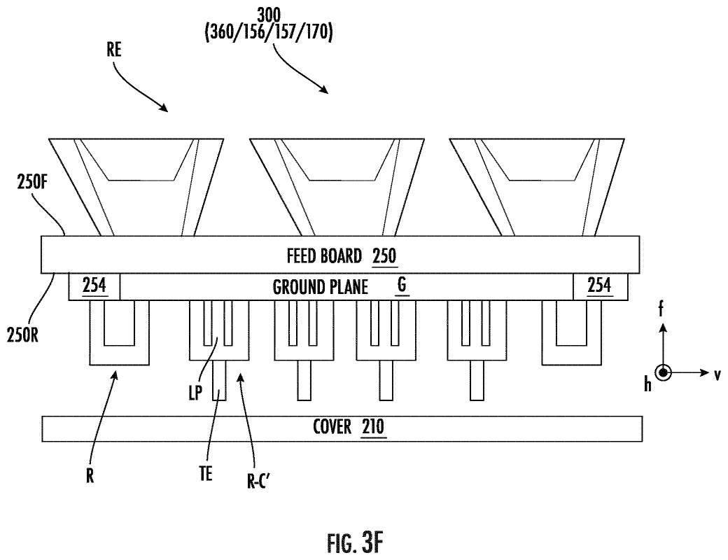

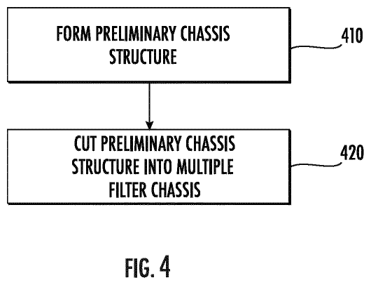

FIG. 3A is a rear perspective view of a filter device 165 comprising an RF filter bank 360 with a cover 210 (FIG. 2A) thereof removed, according to other embodiments of the present invention. Each filter F in the filter bank 360 may have a larger number of resonators R than the filter bank 260 (FIG. 2B). For example, each filter F in the filter bank 360 may comprise twelve resonators R, whereas each filter F in the filter bank 260 may comprise nine resonators R.

As with the filter bank 260, each filter F in the filter bank 360 may comprise two hanging-rejection resonators R-H, which are in respective hanging-rejection cavities 240. Also like the filter bank 260, each filter F in the filter bank 360 may comprise two resonators R-C that are coupled to the resonators R-H, respectively, by respective RF transmission lines 254 (FIG. 2C).

The remaining eight resonators R of each filter F in the filter bank 360 may comprise two rows of capacitively-coupled resonators R-C′ that can have a narrower length and/or a larger number of leg portions LP (FIG. 2F) than the resonators R-C, R-H. As an example, each resonator R-C′ may be supported by at least three leg portions LP that are physically and electrically coupled to a ground plane G (FIG. 3F) that is on a rear surface 250F (FIG. 3F) of a feed board 250. Moreover, each resonator R-C′ may be capacitively coupled to either (a) two adjacent each resonators R-C′ or (b) one adjacent resonator R-C′ and one adjacent resonator R-C.

According to some embodiments, the resonators R of each filter F shown in FIG. 3A may collectively provide two transmission zeros. For example, each of the two hanging-rejection cavities 240 may provide a transmission zero. Moreover, one of the resonators R (e.g., one of the resonators R-C′) may be omitted in some embodiments, thus providing a total of eleven resonators R per filter F.

A height of the device 300 may be, for example, less than 20 mm. A length of the device 300 may be less than 110 mm. According to some embodiments, however, a low-pass filter, such as the LPF 256 (FIG. 2C), may be included in the device 300, which may extend the length beyond 110 mm.

FIG. 3B is a rear perspective view of one of the resonators R-C′ of FIG. 3A. The resonator R-C′ is not limited to a particular number of leg portions LP. In some embodiments, the resonator R-C′ may be supported by four leg portions LP thereof, as shown in FIG. 3B. For example, a top face of a four-legged resonator R-C′ may be cross-shaped. In other embodiments, the resonator R-C′ may be supported by two or three leg portions LP. As an example, the resonator R-C′ may have three leg portions LP that support the top face of the resonator R-C′ and a fourth leg portion LP that is bent (e.g., upward) to function as a tuning element/stub TE (FIG. 3F) rather than a structural support.

FIG. 3C is a side perspective view of another type of resonator R-C″ that can be part of the filter bank 360 of FIG. 3A. The resonator R-C″ has leg portions LP that are spaced apart from each other by a distance that narrows as the leg portions LP approach a rear surface 250R of a feed board 250 (FIG. 3A). For example, the resonator R-C″ may have a conical shape or an inverted-pyramid shape. As a result, the resonator R-C″ may provide better performance, including a higher quality (“Q”) factor, than a resonator having parallel leg portions. In some embodiments, the leg portions LP of the resonator R-C″ may cross each other. In other embodiments, the leg portions LP of the resonator R-C″ may approach each other without crossing.

FIGS. 3D and 3E are examples of further types of RF filters that can be part of the filter bank 360 of FIG. 3A. As shown in FIG. 3D, all resonators R of a filter 380 may be part of a monolithic metal sheet 381 that is coupled (e.g., soldered) to a rear surface 250R of a feed board 250 (FIG. 3A). In some embodiments, each resonator R may include a laterally-protruding portion 370 that protrudes toward, and is capacitively coupled to, another of the resonators R (e.g., another protruding portion 370 thereof). Moreover, the metal sheet 381 may include a linking portion 385 that physically connects adjacent resonators R to each other, thereby providing strong inductive coupling between the adjacent resonators R. For example, each resonator R of the filter 380 may be inductively coupled to another resonator R by a linking portion 385 of the metal sheet 381. As an example, the resonators R may be linked arch-shaped resonators.

Referring to FIG. 3E, a notch-type filter 390 may comprise a plurality of resonators R that are each electrically connected to the same RF transmission line 395 that is on a rear surface 250R of a feed board 250 (FIG. 3A). For example, three, four, five, or more resonators R may each be electrically connected to the same transmission line 395. The resonators R may be electrically isolated from each other by conductive walls, such as the walls 232, 234 (FIG. 2D). As an example, the walls 232, 234 may be repeated and arranged to enclose the resonators R on, for example, three sides, such that each resonator R may be in a different resonator cavity from the other resonators R. In some embodiments, the filter 390 may comprise a band-stop filter that is configured to reject particular frequencies.

FIG. 3F is a schematic side view of the feed board 250 of FIG. 3A with a cover 210 thereon. The feed board 250 is part of an RF device 300, which integrates the filter bank 360 of a filter device 165 with a plurality of radiating elements RE (e.g., of the same array 170) on the feed board 250. In some embodiments, the device 300 may also include feed circuitry 156/157 (FIG. 1C) on the feed board 250. For simplicity of illustration, conductive walls W (FIG. 3A) and RF connectors 220 (FIG. 3A) are omitted from view in FIG. 3F.

A plurality of tuning elements TE may be coupled to respective resonators R that are on the feed board 250. For example, the tuning elements TE may be coupled to some (but not necessarily all) of the resonators R that are on the feed board 250. The resonators R are part of the filter bank 360.

According to some embodiments, the tuning elements TE may not extend through the cover 210. Rather, the tuning elements TE may be integrated with resonators R-C′ or may otherwise not penetrate an outer surface of the cover 210. As an example, a tuning element TE may be a metal tab or metal spiral on the top face of a resonator R-C′. By having the tuning elements TE on the inside of the filter device 165 (FIG. 3A), such as under the cover 210, rather than on/through the outside of the cover 210, RF leakage can be reduced. For example, tuning elements TE that are below the cover 210 (e.g., tuning elements TE that are implemented as tabs or stubs etched on or attached to the resonators R-C′) may be less prone to radiate (which radiation can cause RF leakage) than the same kind of tuning element etched on or attached to the cover 210. In some embodiments, the cover 210 thus may not have any openings therein that overlap, in the forward direction f, any resonators R. In other embodiments, the cover 210 may have openings therein that overlap respective resonators R in the forward direction f.

As described above with respect to FIG. 2E, a plurality of radiating elements RE may extend forward from a front surface 250F of the feed board 250 that is opposite a rear surface 250F thereof having resonators R thereon. The resonators R may include resonators R-C′ that each have at least three leg portions LP that are mounted on (e.g., soldered to) a ground plane G that is on the rear surface 250R. As further described above with respect to FIG. 2E, the radiating elements RE may have various shapes and/or structures, and thus are not limited to the example shapes/structures shown in FIG. 3F.

FIG. 4 is a flowchart illustrating operations of forming the conductive walls W of FIG. 2D. Moreover, the operations may be used to form the conductive walls W of FIG. 3A by rearranging/resizing conductive walls 232, 234 with respect to the positions/lengths thereof that are shown in FIG. 2D. The operations of forming conductive walls W may include forming (Block 410) a preliminary chassis structure that includes at least four outer conductive walls and at least three inner conductive walls that physically connect two of the outer conductive walls to each other. The outer conductive walls correspond to, and are taller (e.g., in the forward direction f (FIG. 2E)) than, the outer conductive walls W-1 through W-4. The inner conductive walls correspond to, and are taller (e.g., in the forward direction f) than, the inner conductive walls W-5 through W-7 shown in FIG. 2D.

The preliminary chassis structure is cut (Block 420) into a plurality of filter chassis, which may be implemented as a plurality of conductive housings 230 (FIG. 2D), respectively. Each housing 230 may define resonator cavities for a plurality of RF filters F that are in a filter bank 260 (FIG. 2B) or 360 (FIG. 3A). Accordingly, the preliminary chassis structure may be cut to provide housings 230 for a plurality of filter banks 260/360, respectively.

In some embodiments, the preliminary chassis structure may be formed by extruding metal in a height direction of the conductive walls that are connected to each other. Moreover, cutting the preliminary chassis structure may include cutting the extruded/extended metal along a lateral direction that is perpendicular to the height direction.

RF devices 200, 300 (FIGS. 2E, 3F) according to embodiments of the present invention may provide a number of advantages. These advantages include providing a more-compact, lighter-weight, and/or lower-cost antenna 100 (FIG. 1C) by integrating RF filters F (FIGS. 2B, 3A) with a feed board 250 that feeds radiating elements RE (FIGS. 2E, 3F). For example, the filters F may be mounted on an opposite side of the feed board 250 from the radiating elements RE. Accordingly, the filters F and the feed board 250 may be a single, integrated component rather than separate components.

In some embodiments, one or more materials of the devices 200, 300 may be selected to provide good thermal (e.g., temperature) compensation. As an example, resonators R (FIGS. 2B, 3A) of the filters F may comprise steel.

Moreover, the devices 200, 300 can have good RF performance. For example, the device 200 can achieve a lower-side guard band (between a stop band and a pass band) of about 13 megahertz (“MHz”). This can leave about 7 MHz to account for temperature drift, design, and tuning margins. First spurious/parasitic resonances for the device 200 may appear at about 8.5 GHZ, and center-band insertion loss may be about 0.5 decibels (“dB”). As another example, the device 300 can achieve a lower-side guard band of about 10 MHz, which can leave about 10 MHz to account for temperature drift, design, and tuning margins. First spurious/parasitic resonances for the device 300 may appear at about 9 GHz, and center-band insertion loss may be about 0.6 dB.

The present invention has been described above with reference to the accompanying drawings. The present invention is not limited to the illustrated embodiments. Rather, these embodiments are intended to fully and completely disclose the present invention to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” “coupled,” and the like can mean either direct or indirect attachment or coupling between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

1. A radio frequency (RF) device comprising:
a feed board comprising a first surface having a plurality of radiating elements thereon; and
a filter bank comprising a plurality of RF filters that each comprise a plurality of resonators that are mounted on a second surface of the feed board that is opposite the first surface.

2. The RF device of claim 1, wherein the second surface of the feed board comprises a ground plane thereon, and the resonators are mounted on the ground plane.

3. The RF device of claim 2,
wherein the second surface of the feed board further comprises an RF transmission line thereon,
wherein a first portion of an underside of a first of the resonators overlaps the RF transmission line, and
wherein a second portion of the underside of the first of the resonators overlaps the ground plane.

4. The RF device of claim 3, wherein a second of the resonators comprises opposite first and second ends that are both coupled to the ground plane.

5. The RF device of claim 4,
wherein the first and second ends are ends of first and second leg portions, respectively, of the second of the resonators, and
wherein the second of the resonators further comprises a third leg portion that is coupled to the ground plane.

6. The RF device of claim 5, further comprising:
a cover that covers the resonators; and
a plurality of tuning elements that are coupled to some of the resonators and do not extend through the cover.

7. The RF device of claim 3, wherein the underside of the first of the resonators comprises a suspended surface that is opposite and spaced apart from the second surface of the feed board.

8. The RF device of claim 7, wherein the first of the resonators further comprises first and second leg portions that support the suspended surface of the first of the resonators.

9. The RF device of claim 1, wherein the resonators are sheet-metal resonators, respectively.

10. The RF device of claim 9, wherein the sheet-metal resonators are soldered to the feed board.

11. The RF device of claim 1, further comprising a low-pass filter that is coupled to the filter bank.

12. The RF device of claim 11, wherein the low-pass filter is on the first surface or the second surface of the feed board.

13. The RF device of claim 1, further comprising a conductive wall that electrically isolates a first of the RF filters from a second of the RF filters.

14. The RF device of claim 1, wherein a first of the resonators comprises first and second leg portions having a distance therebetween that narrows as the first and second leg portions approach the second surface of the feed board.

15. The RF device of claim 1,
wherein a first and a second of the resonators are part of the same metal sheet,
wherein the first of the resonators comprises a protruding portion that protrudes toward, and is capacitively coupled to, the second of the resonators, and
wherein a linking portion of the metal sheet inductively couples the first and the second of the resonators to each other.

16. The RF device of claim 1, further comprising an RF transmission line on the second surface of the feed board,
wherein a first, a second, and a third of the resonators are each electrically connected to the RF transmission line and are in different resonator cavities from each other.

17. A radio frequency (RF) device comprising:
a feed board comprising:
a first surface having a plurality of radiating elements thereon; and
a second surface opposite the first surface and having a ground plane thereon; and
a filter bank on the second surface of the feed board, the filter bank comprising a plurality of RF filters that each comprise a plurality of sheet-metal resonators that are coupled to the ground plane.

18. The RF device of claim 17,
wherein the second surface of the feed board further comprises a plurality of RF transmission lines thereon, and
wherein the sheet-metal resonators comprise:
first resonators that overlap the RF transmission lines; and
second resonators that each have at least two leg portions that are coupled to the ground plane.

19. A radio frequency (RF) device comprising:
a feed board comprising a ground plane thereon and an RF transmission line thereon; and
a filter bank on the ground plane, the filter bank comprising a plurality of RF filters that each comprise a plurality of resonators that are coupled to the ground plane,
wherein a first portion of an underside of a first of the resonators overlaps the RF transmission line, and
wherein a second portion of the underside of the first of the resonators overlaps the ground plane.

20. The RF device of claim 19, wherein a second of the resonators has at least three leg portions that are mounted on the ground plane.

21.-22. (canceled)
